(19) United States
(12) Patent Application Publication
(10) Pub. No.: US 2008/0174999 A1
(43) Pub. Date: Jul. 24, 2008

(54) BACK LIGHT MODULE AND LUMINAIRE WITH DIRECT TYPE LIGHT GUIDE PLATE

(75) Inventor: Cheng-Ting Chiang, Sinjhuang City (TW)

Correspondence Address: SNELL & WILMER L.L.P. (Main), 400 EAST VAN BUREN, ONE ARIZONA CENTER, PHOENIX, AZ, 85004-2202, US

(73) Assignees: Cheng-Ting Chiang, Sinjhuang City (TW); ONION TECHNOLOGY CORPORATION, Sinjhuang City (TW)

(21) Appl. No.: 11/839,769

(22) Filed: Aug. 16, 2007

(30) Foreign Application Priority Data
Aug. 21, 2006 (TW) 095130636

(51) Int. Cl. F21V 7/04; F21V 7/00

(52) U.S. Cl. 362/247; 362/343

(57) ABSTRACT

A backlight module including a printed circuit board, multiple light emitting diodes, and a light guide plate is disclosed. The multiple light emitting diodes can be arranged in an array or arbitrarily on the printed circuit board to provide the necessary light source for the back light module. The light guide plate with a light input surface and a light output surface is disposed on the multiple light emitting diodes. The light guide surface of the light guide plate may be flat or curved. A plurality of recesses on the light output surface of the light guide plate are configured to have the light from the light emitting diodes achieve total internal reflection effectively so that the lights are uniformly mixed in the light guide plate prior to emitting from the light guide plate. Therefore, light emitted from the light output surface of the light guide plate has higher brightness and more uniform energy.

### CROSS REFERENCE TO RELATED APPLICATIONS

This application claims priority to Taiwan Patent Application Serial No. 95130636 entitled “BACK LIGHT MODULE WITH DIRECT TYPE LIGHT GUIDE PLATE AND LIGHTING DEVICE,” filed on Aug. 21, 2006.

### TECHNICAL FIELD

The present invention relates to a back light module, and more particularly to a back light module with a direct type light guide plate, in which the structure of the light guide plate makes the light provided by light emitting devices achieve total internal reflection.

### BACKGROUND OF THE INVENTION

Back light modules are conventionally edge type, in which the light is guided into the module from the edge of the light guide plate (LGP) to unify the light. However, in this way, the energy of the light with a large angle is not efficiently utilized, and the space for arranging light sources is limited to the edge of the module. Consequently, the brightness of the back light module is limited.

As techniques of the liquid crystal display (LCD) are developed, LCD panels are applied more broadly, such as displays of digital cameras, personal digital assistants (PDAs), computers, mobile phones and televisions. The back light module is one of the key components of the LCD.

Back light modules are mostly edge type, which refers to the location of the light source. The light source of the edge type back light module may be located at one or two edges of the back light module and the emitted light is guided by the light guide plate in order to provide an area light source. A conventional edge type backlight module includes light emitting diodes, a light guide plate and a reflector. The light emitting diodes serve as the light source, and the emitted lights are then mixed by the light guide plate and reflected by the reflector to provide uniform propagation of the light. The edge type back light module benefits from the smaller thickness, while it is subject to the lower brightness.

### SUMMARY OF THE INVENTION

In light of the disadvantages of the conventional back light module with an edge type light guide plate, the present invention provides a back light module with a direct type light guide plate to provide higher brightness and more uniform energy.

One object of the present invention is to provide a light guide plate having a light guide structure by which the light provided by the light emitting diodes are totally internally reflected in the light guide plate to achieve higher brightness and more uniform energy.

Another object of the present invention is to provide a light guide plate having a light output surface with a light guide structure, and a light input surface being a non-flat surface of random curvature. The light provided by the light emitting diodes are totally internally reflected in the light guide plate via the non-flat surface, and uniformly-mixed light with higher brightness and more uniform energy is provided.

Still another object of the present invention is to dispose multiple dots or microlenses on the light guide surface of the light guide plate, or v-cut structures on the light output surface. The light provided by the light emitting diodes would be totally internally reflected in the light guide plate, and the dots, microlenses or v-cut structures would change the refraction direction and reflection angle of the light as the light is reflected. Thus the reflected light may be emitted from the light output surface of the light guide plate at predetermined locations.

According to the objects mentioned above, a back light module is disclosed. The backlight module includes a printed circuit board, multiple light emitting diodes, and a light guide plate. The multiple light emitting diodes may be arranged on the printed circuit board in an array or other arbitrary arrangements to provide the necessary lights for the back light module. The light guide plate is disposed on the multiple light emitting diodes. The light input surface of the light guide plate may be flat or non-flat. The light output surface of the light guide plate has a light guide structure including multiple recesses. The light guide structure is configured to have the lights provided by the light emitting diodes to achieve total internal reflection in the light guide plate. Therefore, the light is uniformly mixed in the light guide plate prior to emitting from the light output surface of the light guide plate. And the light emitted from the light output surface of the light guide plate has improved brightness and uniform energy.

### BRIEF DESCRIPTION OF THE DRAWINGS

FIG. 1 is a top view of a back light module having a direct type light guide plate according to one embodiment of the present invention;

FIGS. 2A-2C are schematic diagrams illustrating back light modules according to the first, second and third preferred embodiments of the present invention;

FIGS. 3A and 3B are schematic diagrams illustrating back light modules according to the fourth and fifth preferred embodiments of the present invention; and

FIGS. 4A and 4B are schematic diagrams illustrating back light module according to the sixth and seventh preferred embodiments of the present invention.

### DETAILED DESCRIPTION OF THE PREFERRED EMBODIMENTS

Several embodiments of the present invention will be described in detail below. However, the present invention may be applied broadly to other embodiments. The present invention is not limited to the detailed description, and the scope of the present invention should be construed according to the appended claims.

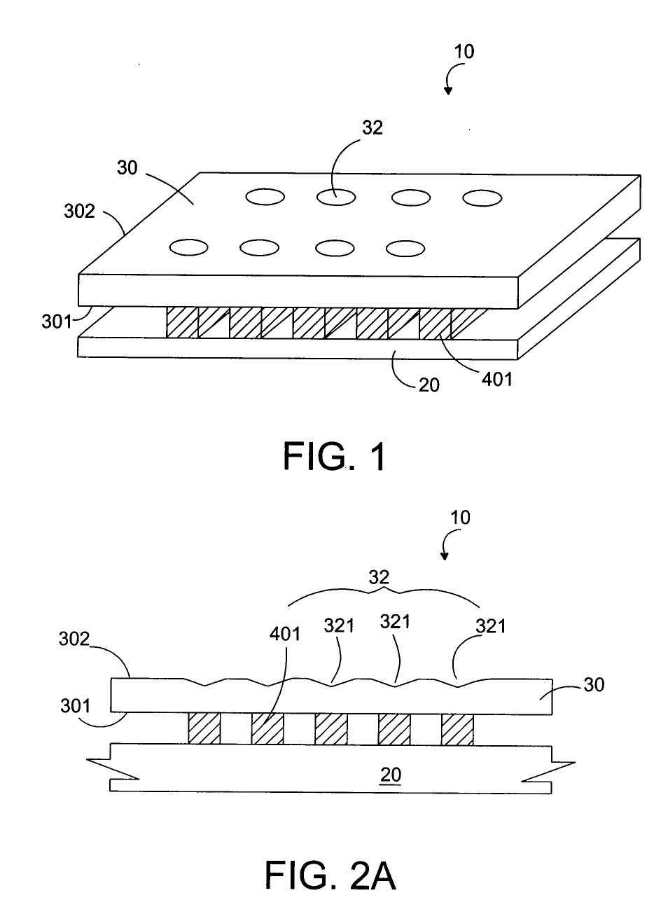

Referring to FIG. 1, a top view of a back light module having a direct type light guide plate according to the present invention is illustrated. The back light module 10 includes a printed circuit board 20, multiple light emitting diodes 401 and a light guide plate 30 having a light guide structure 32. The multiple light emitting diodes 401 may be disposed on the printed circuit board 20 as an array or in random to provide light with various required wavelengths. In this embodiment, the light guide structure 32 is arranged corresponding to multiple light emitting diodes 401. The multiple light emitting diodes 401 include multiple light emitting diode chips having identical or different wavelengths, such as white light emitting diode chips or RGB light emitting diode chips. The wavelength may range from about 420 nm to 680 nm, and the color temperature may range from about 2,200K to 10,000K.

Besides, the light guide plate 30 has a light input surface 301 and a light output surface 302. The light guide structure 32 is disposed on the light output surface 302, and the light guide structure 32 includes an inclined surface. The inclined surface may be a surface with arbitrary curvature. The inclined surface may be embodied as any shape capable of making the light emitted from the light emitting diodes 401 be totally internally reflected in the light guide plate 30 to achieve an uniformly mixed light source. The light guided by the light guide structure 32 is totally internally reflected in the light guide plate 30, and the resulted light with improved brightness and uniform energy is emitted through the light output surface 302 of the light guide plate 30. In the disclosed embodiments of the present invention, the light guide plate 30 may be made of glass, polymethylmethacrylate (PMMA), polycarbonate (PC), cyclo olefin copolymer (COC), PET or other polymeric materials as appropriate.

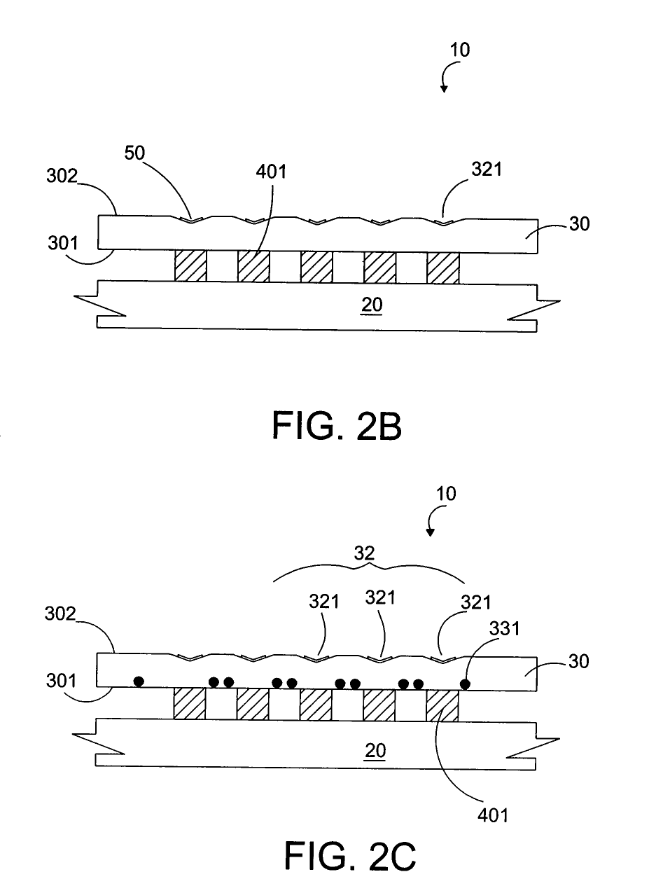

FIGS. 2A, 2B and 2C illustrate back light modules having a direct type light guide plate according to the first, second and third preferred embodiments of the present invention. First, referring to FIG. 2A, the back light module 10 of this embodiment includes a printed circuit board 20, and multiple light emitting diodes 401 disposed on the printed circuit board 20 as an array or arbitrary arrangement. A light guide plate 30 having a first surface 301 and a second surface 302 is disposed on the multiple light emitting diodes 401. In this embodiment, the first surface 301 of the light guide plate 30 is a light input surface, e.g. a flat surface, and the second surface 302 of the light guide plate 30 is a light output surface having a light guide structure 32 having multiple recesses 321. The light guide structure 32 is configured to guide the light emitted from the light emitting diodes 401 into the light guide plate 30 with a total internal reflection effect. Then the light is totally internally reflected in the light guide plate 30 to make the light source be mixed uniformly to improve brightness. Finally, the light is emitted from the light output surface 302 of the light guide plate 30.

Additionally, in this embodiment, each light emitting diode is located corresponding to each recess 321 of the light guide plate 30. In this way, the light emitted from the light emitting diodes 401 may be guided into the light guide plate 30 efficiently and be totally internally reflected in the light guide plate 30 via the surface (not shown in FIGS. 2A and 2B) of the recesses 321.

It is noted that, in each embodiment disclosed in the present invention, the multiple light emitting diodes 401 are described and shown in the drawings as being disposed on the printed circuit board 20 in an array. However, it is not intended to limit the arrangement of the light emitting diodes 401, and the light emitting diodes 401 may be arranged arbitrarily on the printed circuit board 20.

The light emitted from the light emitting diodes 401 enters the light guide plate 30 through the light input surface (the first surface) 301 of the light guide plate 30, and is totally internally reflected via the multiple recesses 321 of the light output surface (the second surface) 302 of the light guide plate 30. Therefore the light is totally internally reflected and thus mixed uniformly in the light guide plate 30, and is emitted from the second surface (the light output surface) 302 of the light guide plate 30.

Similarly, referring to FIG. 2B, a schematic diagram of a back light module having a direct type light guide plate according to another preferred embodiment of the present invention is illustrated. The denominations, materials and functions of the elements shown in FIG. 2B are the same as disclosed in FIG. 2A and the description of such is omitted here for conciseness. The difference between FIG. 2B and FIG. 2A lies in that, to make the light emitted from the light emitting diodes 401 be totally internally reflected before propagating within the light guide plate 30, and to mix the light uniformly in the light guide plate 30, a reflective layer 50 is provided on the inclined surface (the concave portion) of the multiple recesses 321 of the second surface 302. The reflective layer 50 may be made of dielectrics or metals and may be formed by coating or sputtering. The light emitted from the light emitting diodes 401 is guided into the light guide plate 30, incident on the reflective layer 50, and reflected/refracted. Then light is uniformly mixed to improve brightness. Thereafter, the mixed light is emitted from the portion (not covered with the reflected layer 50) of the light output surface 302 of the light guide plate 30. It is noted that the reflective layer 50 may be omitted if the recesses 321 are designed to be capable of making the lights be totally internally reflected. However, if the total internal reflection of the lights could not be ensured by the recesses 321 due to some possible tolerance of manufacturing, the reflective layer 50 may be utilized to make the light be guided into the light guide plate 30 and totally internally reflected within the light guide plate 30. Therefore, the reflective layer 50 is intended to make the light be guided into the light guide plate 30 with the total internal reflection effect, thus the shapes, sizes and locations thereof are not limited by the above embodiments.

Referring to FIG. 2C, a schematic diagram of a back light module having a direct type light guide plate according to yet another preferred embodiment of the present invention is illustrated. Likewise, the denominations, materials and functions of the elements shown in FIG. 2C are the same as disclosed in FIGS. 2A and 2B and are not described here for conciseness. The difference between FIG. 2C and FIG. 2B lies in that multiple dots 331, microlenses (not shown) are disposed under the light guide plate 30 in FIG. 2C. The dots 331 are provided for the light guide structure 32 of the light guide plate 30 to make the light emitted from the light emitting diodes 401 be totally internally reflected after entering the light guide plate 30. The dots 331 may change the reflection path and reflection angle of the lights in the light guide plate 30 as the lights are incident thereon so that the lights may be emitted from the light output surface 302 of the light guide plate 30 through expected locations. It is noted that, besides the dots 331, microlenses (not shown) may also be disposed under the light guide plate 30. The dots 331 are applied to the embodiments and the corresponding drawings only for the illustrating purpose but not limitation. For example, v-cut structures (not shown) may also be disposed at expected locations on the light output surface 302. And the refraction angle of the lights would be changed as the light is totally internally reflected to the side edges of the v-cut structure in the light guide plate 30; thus, the light may be emitted from the light guide plate 30.

Furthermore, to improve the brightness and uniformity of energy of the light emitted from the light emitting diodes, the concave portion of the light guide structure 32 further includes a reflective layer 50, such as a metal coating layer. With the light guide structure 32 and the reflective layer 50 in the light guide plate 30, the light emitted from the light emitting diodes 401 may be reflected/refracted by the reflective layer 50 after entering the light guide plate 30, and the light is thus mixed uniformly with higher brightness. Subsequently, the reflection/refraction path of the lights may be changed by the dots 331, microlenses or v-cut structures in the light guide plate 30, and the light is thus emitted from the portion (not covered with the metal layer 50) of the light output surface 302 of the light guide plate 30.

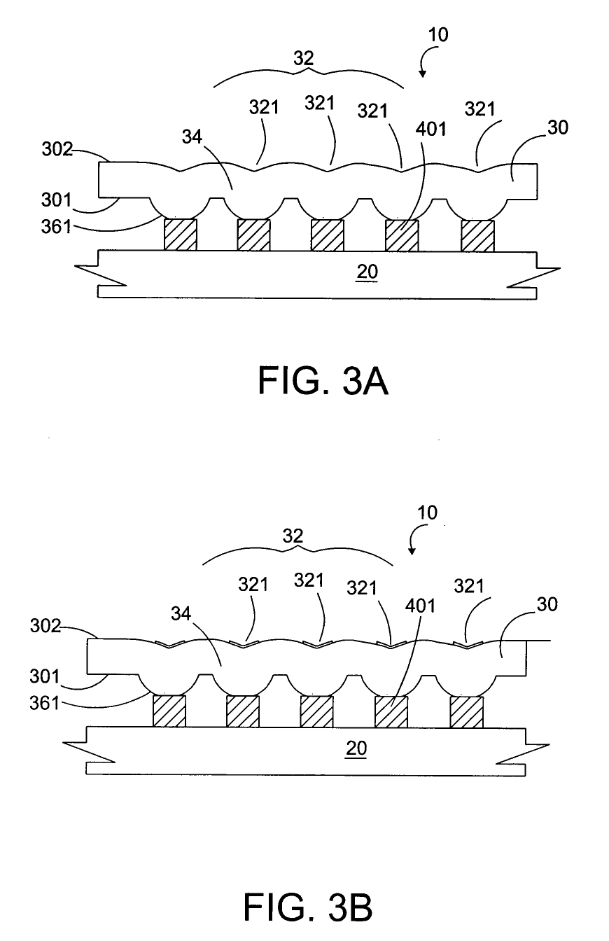

FIGS. 3A and 3B illustrate back light modules having a direct type light guide plate according to the fourth and fifth preferred embodiments of the present invention. First, referring to FIG. 3A, a back light module 10 includes a printed circuit board 20, multiple light emitting diodes 401 and a light guide plate 30. The multiple light emitting diodes 401 are arranged on the printed circuit board 20 in an array and located below a first surface 301 of the light guide plate 30. Besides, the first surface 301 of the light guide plate 30 includes a non-flat surface 361. The non-flat surface 361 may be a spherical or aspherical surface, such as a bowl shape, U shape, or a surface with an arbitrary curvature. A second surface 302 of the light guide plate 30 has a light guide structure 32 including multiple recesses 321. In this embodiment, the first surface 301 of the light guide plate 30 is designed to be a non-flat surface 361, so that the lights emitted from the light emitting diodes 401 are totally internally reflected within the light guide plate 30 via the non-flat surface 361, and the lights are then mixed uniformly in the light guide plate 30.

Therefore, in this embodiment, the light emitted from light emitting diodes 401 would enter the light guide plate 30 through the surface 34 of the non-flat surface 361 at different angles resulted from the non-flat surface 361. Then the light is totally internally reflected via the light guide structure 32 of the second surface 302 of the light guide plate 30. Thus a uniformly mixed light is achieved in the light guide plate 30 and emitted from the second surface (light output surface) 302 of the light guide plate 30.

According to above description, the advantages of this embodiment lie in that the light emitted from the light emitting diodes 401 may be totally internally reflected in the light guide plate 30 via the non-flat surface 361 in conjunction with the light guide structure 32, so that the light is uniformly mixed in the light guide plate 30 and a light having a high brightness and uniform energy is obtained. Thereafter, the mixed lights are emitted from the second surface (light output surface) 302 of the light guide plate 30.

Next, referring to FIG. 3B, a schematic diagram illustrating a back light module according to another preferred embodiment of the present invention is shown. The denominations, materials and functions of the elements shown in FIG. 3B are the same as disclosed in FIG. 3A and the description of such is thus omitted here for conciseness. The difference between FIG. 3B and FIG. 3A lies in that, to make the light emitted from the light emitting diodes 401 be totally internally reflected in the light guide plate 30, a reflective layer 50 is provided on the inclined surface (the concave portion) of the multiple recesses 32 on the light guide plate 30. The reflective layer 50 may be made of dielectrics or metals.

When the light emitted from the light emitting diodes 401 enters the light guide plate 30 to the light guide surface 301 of the light guide plate 30, the light is reflected by the light guide structure 32, and the light is uniformly mixed within the light guide plate 30. Additionally, after being guided into the light guide plate 30, the light emitted from the light emitting diodes 401 are incident on the reflective layer 50, on which the light is reflected/refracted. A well-mixed light source with higher brightness is thus achieved. The light may be totally internally reflected and not subject to loss, then emitted from the second surface (light output surface) 302 of the light guide plate 30.

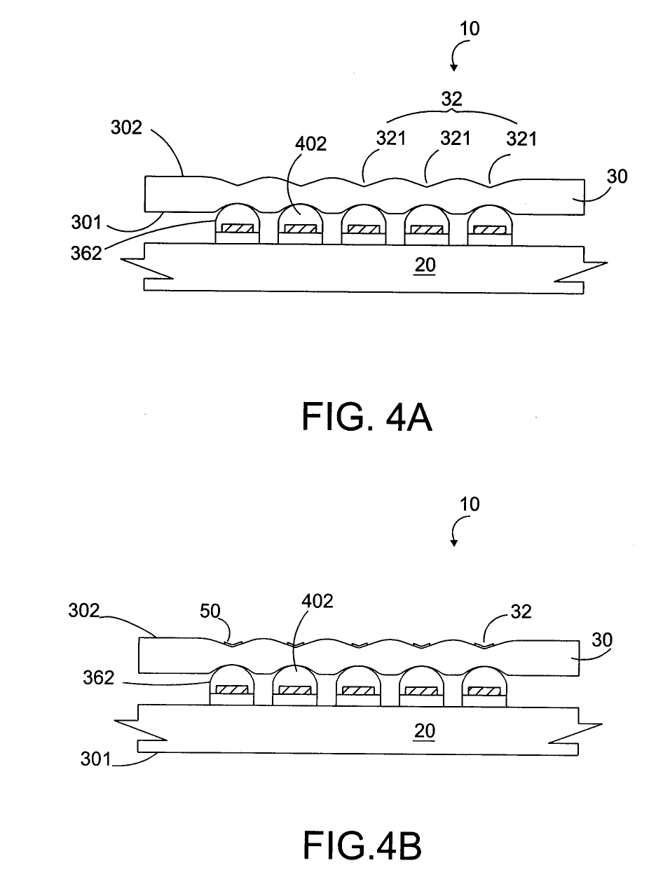

FIGS. 4A and 4B are schematic diagrams illustrating back light modules having a direct type light guide plate according to the sixth and seventh preferred embodiments of the present invention. First, referring to FIG. 4A, a back light module 10 includes a printed circuit board 20, multiple light emitting diode package devices 402, and a light guide plate 30 having a first surface 301 and a second surface 302. The multiple light emitting diode package devices 402 are arranged on the printed circuit board 20 in an array. In this embodiment, the multiple light emitting diode package devices 402 may be multiple light emitting diode chips. In another embodiment, however, it may use only one single light emitting diode chip. Furthermore, the second surface 302 of the light guide plate 30 has a light guide structure 32 including multiple recesses 321, and the first surface includes a non-flat surface 362. The non-flat surface 362 may be of inversed bowl shape, U shape or a surface with arbitrary curvature. The curvature of the multiple recesses 321 may be the same as or different from the curvature of the first surface 301 having the non-flat surface 362.

In this embodiment, the light emitted from the light emitting diodes 402 may enter the light guide plate 30 at different angles through the non-flat surface 362. Subsequently, the light may be totally internally reflected in the light guide plate 30 via the first surface 301 of the light guide plate 30 in conjunction with the multiple recesses 321, so that the light is uniformly mixed in the light guide plate 30. Then the light is emitted from the second surface (light output surface) 302 of the light guide plate 30.

According to above description, the advantages of this embodiment lie in that the light provided by the light emitting diode package devices 402 can be totally internally reflected in the light guide plate 30 by the non-flat surface 362 of the light guide plate 30 in conjunction with the light guide structure 32, so that the lights are uniformly mixed in the light guide plate 30 and a light source is provided with higher brightness and more uniform energy and emitted from the second surface (light output surface) 302 of the light guide plate 30.

Next, referring to FIG. 4B, a schematic diagram illustrating a back light module according to another preferred embodiment of the present invention is shown. The denominations, materials and functions of the elements shown in FIG. 4B are the same as disclosed in FIG. 4A and therefore the description of such are omitted here for conciseness. The difference between FIG. 4B and FIG. 4A lies in that, to make the light provided by the light emitting diode package devices 402 be total internal reflected in the light guide plate 30, a reflective layer 50 is provided on the multiple recesses 321 of the light guide plate 30 (the concave portion). The reflective layer 50 may be made of dielectrics or metals.

Similarly, when the light emitted from the light emitting diode package devices 402 enters the light guide plate 30 and is reflected by the light guide surface 301 of the light guide plate 30, the light is totally internally reflected via the multiple recesses 321 at the second surface 302 of the light guide plate 30, and the light is thus mixed uniformly. Additionally, the light is reflected/refracted by the reflective layer 50 on the inclined surface of the multiple recesses 321, then emitted from the second surface (light output surface) 302 of the light guide plate 30.

The back light module 10 having a direct type light guide plate of each embodiment disclosed by the present invention may be broadly applied to the luminaries (not shown) by disposing the back light module having the direct type light guide plate 30 in the luminaries. The light guide structure 32 of the direct type light guide plate 30 may make the lights emitted from the light emitting diodes 401 or 402 be guided into the light guide plate with the total internal reflection effect. Then a totally internally reflected light is obtained, and emitted from the light output surface of the light guide plate with improved brightness and uniform energy. Therefore, the back light modules may further be applied to luminaries with an excellent light emitting efficiency.

The description shown above is only about the preferred embodiments of the present invention and is not intended to limit the scope of the invention. Any equivalent variations or modifications without departing from the spirit disclosed by the present invention should be included in the appended claims.

We claim:

1. A back light module, comprising:
a light guide plate having a first surface and a second surface, said second surface having a light guide structure; and
a light source disposed below said first surface of said light guide plate, said light source corresponding to said light guide structure,
wherein said light guide structure guides light from said light source to be totally internally reflected in said light guide plate.

2. The back light module according to claim 1, wherein said light guide structure is comprises multiple recesses.

3. The back light module according to claim 2, wherein said multiple recesses are arbitrarily arranged on said second surface.

4. The back light module according to claim 2, wherein said multiple recesses are arranged on said second surface in an array.

5. The back light module according to claim 2, wherein an inclined surface of each of said multiple recesses further comprises a reflective layer.

6. The back light module according to claim 5, wherein said reflective layer is made of dielectrics or metals.

7. The back light module according to claim 1, wherein said first surface is a flat surface.

8. The back light module according to claim 1, wherein said first surface is a surface with arbitrary curvature.

9. The back light module according to claim 1, wherein said light source comprises light emitting diodes or light emitting diode package devices.

10. A light guide plate, comprising:
a first surface; and
a second surface having a light guide structure, and said light guide structure guiding a light from a light source to be totally internally reflected in said light guide plate.

11. The light guide plate according to claim 10, wherein said first surface is a flat surface.

12. The light guide plate according to claim 10, wherein said first surface is a non-flat surface.

13. The light guide plate according to claim 12, wherein said non-flat surface is a surface of bowl shape or U shape, or a curved surface.

14. The light guide plate according to claim 10, wherein said light guide structure includes multiple recesses.

15. The light guide plate according to claim 14, further comprising a reflective layer on an inclined surface of each of said multiple recesses.

16. The light guide plate according to claim 10, further comprising multiple dots, multiple microlenses or multiple v-cut structures on said light guide plate for changing refraction angle of said light.

17. A luminaire, characterized in comprising a light guide plate according to claim 10.
